(19) United States
(12) Patent Application Publication
(10) Pub. No.: US 2009/0320875 A1
(43) Pub. Date: Dec. 31, 2009

(54) DUAL CHAMBER MEGASONIC CLEANER

(75) Inventors: RICARDO MARTINEZ, Manteca, CA (US); Allen L. D'Ambra, Burlingame, CA (US); Adrian Blank, San Jose, CA (US); Thuy Britcher, San Jose, CA (US); Hui Chen, Burlingame, CA (US)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC., Santa Clara, CA (US)

(21) Appl. No.: 12/490,114

(22) Filed: Jun. 23, 2009

Related U.S. Application Data
(60) Provisional application No. 61/075,596, filed on Jun. 25, 2008.

(51) Int. Cl. B08B 3/12

(52) U.S. Cl. 134/1.3; 134/184

(57) ABSTRACT

Embodiments described herein relate to semiconductor device manufacturing, and more particularly to a vertically oriented dual megasonic module for simultaneously cleaning multiple substrates. In one embodiment, an apparatus for cleaning multiple substrates is provided. The apparatus comprises an outer tank for collecting overflow processing fluid comprising at least one sidewall and a bottom. A first inner module adapted to contain a processing fluid is positioned partially within the outer tank. The first inner module comprises one or more roller assemblies to hold a substrate in a substantially vertical orientation. A second inner module adapted to contain a processing fluid is positioned partially within the outer tank. The second inner module comprises one or more roller assemblies adapted to hold a substrate in a substantially vertical orientation. Each inner module contains a transducer adapted to direct vibrational energy through the processing fluid toward the substrates.

### CROSS-REFERENCE TO RELATED APPLICATIONS

This application claims benefit of U.S. provisional patent application Ser. No. 61/075,596, filed Jun. 25, 2008, which is herein incorporated by reference in its entirety.

### BACKGROUND OF THE INVENTION

1. Field of the Invention

Embodiments of the present invention generally relate to apparatuses and methods for cleaning thin substrates, such as semiconductor substrates and the like. More particularly, embodiments of the present invention relate to cleaning of thin substrates using megasonic energy.

2. Description of the Related Art

The effectiveness of an integrated circuit fabrication process is often measured by two related and important factors, which are device yield and the cost of ownership (CoO). These factors are important since they directly affect the cost to produce an electronic device and thus a device manufacturer's competitiveness in the market place. The CoO, while affected by a number of factors, is greatly affected by the system and chamber throughput, or simply the number of substrates per hour processed using a desired processing sequence. In an effort to reduce CoO, integrated circuit manufacturers often spend a large amount of time trying to optimize the process sequence and chamber processing time to achieve the greatest substrate throughput possible given the tool architecture limitations and the chamber processing times.

An integrated circuit is typically formed on a substrate by the sequential deposition of conductive, semiconductive or insulative layers on a silicon wafer. One fabrication step involves depositing a filler layer over a non-planar surface, and planarizing the filler layer until the non-planar surface is exposed. For example, a conductive filler layer can be deposited on a patterned insulative layer to fill the trenches or holes in the insulative layer. The filler layer is then polished until the raised pattern of the insulative layer is exposed. After planarization, the portions of the conductive layer remaining between the raised pattern of the insulative layer form vias, plugs and lines that provide conductive paths between thin film circuits on the substrate. In addition, planarization is needed to planarize the substrate surface for photolithography.

Chemical mechanical polishing (CMP) is one accepted method of planarization. This planarization method typically requires that the substrate be mounted on a carrier or polishing head. The exposed surface of the substrate is placed against a rotating polishing disk pad or belt pad. The polishing pad can be either a “standard” pad or a fixed-abrasive pad. A standard pad has a durable roughened surface, whereas a fixed-abrasive pad has abrasive particles held in a containment media. The carrier head provides a controllable load on the substrate to push it against the polishing pad. A polishing slurry, including at least one chemically-reactive agent, and abrasive particles if a standard pad is used, is supplied to the surface of the polishing pad.

After polishing, be it during wafer or device processing, slurry residue conventionally is cleaned from wafer surfaces via submersion in a tank of cleaning fluid, via spraying with sonically energized cleaning or rinsing fluid, or via a scrubbing device which employs brushes made from bristles, or from a sponge-like material, etc. Although these conventional cleaning devices remove a substantial portion of the slurry residue which adheres to wafer edges, slurry particles nonetheless remain and produce defects during subsequent processing. Specifically, subsequent processing has been found to redistribute slurry residue from the wafer edges to the front of the wafer, causing defects.

Therefore there is a need for a method and apparatus removing for residue from a substrate surface to reduce CoO while achieving a high substrate throughput.

### SUMMARY OF THE INVENTION

Embodiments described herein provide methods and apparatus for cleaning of thin substrates using megasonic energy. Megasonic energy is a type of acoustic energy occurring at a frequency between 800 and 2000 KHz. In one embodiment, an apparatus for cleaning multiple substrates is provided. The apparatus comprises an outer tank for collecting overflow processing fluid comprising at least one sidewall and a bottom. A first inner megasonic module dimensioned to contain a processing fluid and a substrate, wherein the first inner megasonic module is positioned partially within the outer tank. The first inner megasonic module comprises one or more roller assemblies positioned to hold the substrate in a substantially vertical orientation and a transducer positioned in the first inner megasonic module to direct vibrational energy through the processing fluid toward the substrate. A second inner megasonic module dimensioned to contain a processing fluid and a substrate, wherein the second inner megasonic module is positioned partially within the outer tank. The second inner megasonic module comprises one or more roller assemblies positioned to hold the substrate in a substantially vertical orientation and a transducer positioned in the second inner megasonic module to direct vibrational energy through the processing fluid toward the substrate.

In another embodiment, an apparatus for cleaning multiple substrates is provided. The apparatus comprises an outer tank. A first inner megasonic module having vertical walls is coupled with the outer tank. A second inner megasonic module having vertical walls is coupled with the outer tank. Each inner megasonic module comprises a plurality of rotatable roller assemblies positioned to support a substrate in a substantially vertical orientation between the walls and a transducer positioned below the roller assemblies to deliver megasonic energy toward the substrate.

In yet another embodiment, a method for processing multiple substrates is provided. The method comprises introducing each substrate into a separate vertical processing chamber, each vertical processing chamber comprising and inner megasonic module dimensioned to contain a processing fluid and a substrate, wherein the inner megasonic module is dimensioned to contain a processing fluid and a substrate, wherein the inner megasonic module is positioned partially within the outer tank, the inner megasonic module comprising one or more roller assemblies positioned to hold the substrate in a substantially vertical orientation; and a transducer positioned in the inner megasonic module to direct vibrational energy through the processing fluid toward the substrate, rotating the substrates in each inner megasonic module; and directing megasonic energy from below the inner tanks toward the substrates.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a plan view of one embodiment of a chemical mechanical polishing system;

FIG. 2A is a perspective view of one embodiment of a dual megasonic tank cleaner;

FIG. 2B is a cross-sectional perspective view of one embodiment of the dual megasonic tank cleaner of FIG. 2A;

FIG. 3 is a partial cross-sectional view of a side of one embodiment of a megasonic module;

FIG. 4 is a partial cross-sectional view of one embodiment of an inner megasonic tank;

FIG. 5 is a bottom view of one embodiment of the dual megasonic tank cleaner of FIG. 2A; and

FIG. 6 is a partial cross sectional view of one embodiment of a megasonic tank depicting one embodiment of a roller assembly.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the present invention relate to semiconductor device manufacturing, and more particularly to a vertically oriented dual megasonic module for cleaning multiple substrates. One or more transducers may generate megasonic vibrations directed substantially parallel to the major surface(s) of a vertically oriented substrate.

In certain embodiment, the vertical orientation of the dual megasonic module allows for more even distribution of vibrational energy across the surface of the substrate. The improved energy distribution enables a lower wattage to be applied; the lower wattage, in turn, reduces wear on rollers and other components of the module thereby reducing the CoO.

Additionally, because other polishing and/or cleaning modules within a system may process substrates vertically, a single robot can generally service all of the modules of the polishing and cleaning system.

While embodiments described herein will be described in the context of a post-CMP clean of a semiconductor substrate, it should be understood that the methods and apparatus may be used in other parts of the semiconductor circuit fabrication sequence as well as non-semiconductor applications. While the particular apparatus in which the embodiments described herein can be practiced is not limited, it is particularly beneficial to practice the invention in a REFLEXION Lk CMP system and MIRRA MESA® system sold by Applied Materials, Inc., Santa Clara, Calif. Additionally, CMP systems available from other manufacturers may also benefit from embodiments described herein. Embodiments described herein may also be practiced on overhead circular track system including the overhead circular track systems described in U.S. patent application Ser. No. 12/420,996, titled A POLISHING SYSTEM HAVING A TRACK, filed Apr. 9, 2009.

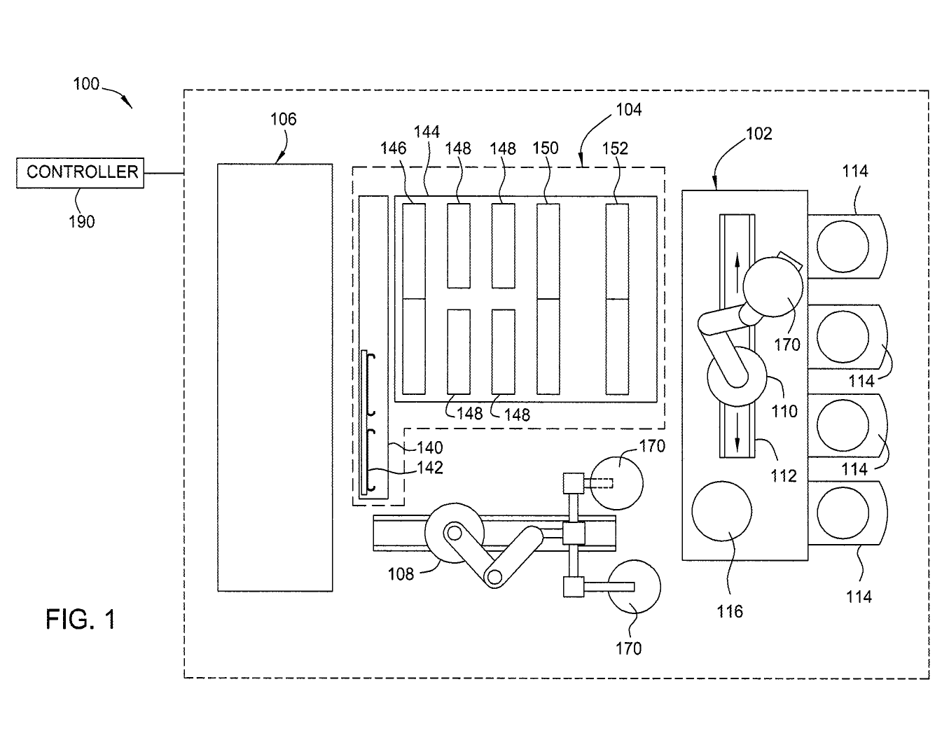

FIG. 1 is a plan view of one embodiment of a chemical mechanical polishing system 100 comprising a dual megasonic tank cleaner 146 according to one embodiment described herein. The chemical mechanical polishing system 100 includes a factory interface 102, a cleaner 104, and a polishing module 106. A wet robot 108 is provided to transfer substrates 170 between the factory interface 102 and the polishing module 106.

The factory interface 102 generally includes a dry robot 110 which is configured to transfer substrates 170 between one or more cassettes 114 and one or more transfer platforms 116. In the embodiment depicted in FIG. 1, four substrate storage cassettes 114 are shown. The dry robot 110 may be mounted on a rail or track 112 to position the robot 110 laterally within the factory interface 102, thereby increasing the range of motion of the dry robot 110. The dry robot 110 additionally is configured to receive substrates from the cleaner 104 and return the clean substrates to the substrate storage cassettes 114.

The polishing module 106 includes a plurality of polishing stations (not shown) on which substrates are polished while retained in one or more polishing heads (not shown). One exemplary polishing module is described in U.S. patent application Ser. No. 12/427,411, titled HIGH THROUGHPUT CHEMICAL MECHANICAL POLISHING SYSTEM, filed Apr. 25, 2009.

Processed substrates are transferred from the polishing module 106 to the cleaner 104 by the wet robot 108. The cleaner 104 generally includes a shuttle 140 and one or more cleaning modules 144. The shuttle 140 includes a transfer mechanism 142 which facilitates hand-off of the processed substrates from the wet robot 108 to the one or more cleaning modules 144. The processed substrates are transferred from the shuttle 140 through a pair of cleaning modules 144 by an overhead transfer mechanism (not shown in FIG. 1). Exemplary embodiments of an overhead transfer mechanism are described in FIGS. 7A-7D and corresponding text of U.S. patent application Ser. No. 12/427,411, titled HIGH THROUGHPUT CHEMICAL MECHANICAL POLISHING SYSTEM, filed Apr. 25, 2009, filed Apr. 15, 2008.

The cleaning modules 144 generally include one or more megasonic cleaners, one or more brush boxes, one or more spray jet boxes, and one or more dryers. In the embodiment depicted in FIG. 1, each of the one or more cleaning modules 144 includes the dual megasonic tank cleaner 146, four brush box modules 148, a spray jet box module 150, and a dryer 152. Dried substrates leaving the dryer 152 are rotated to a horizontal orientation for retrieval by the dry robot 110 which returns the dried substrates 170 to an empty slot in one of the wafer storage cassettes 114. One embodiment of a cleaning module that may be adapted to benefit from the invention is a DESICA® cleaner, available from Applied Materials, Inc., located in Santa Clara, Calif.

A controller 190 may be employed to control operation of the drying modules, such as detecting presence of a substrate, raising/lowering a substrate, controlling delivery or removal of a substrate (via a robot), delivering/supplying of drying vapor during drying, and/or the like. The controller 190 may include one or more microprocessors, microcomputers, microcontrollers, dedicated hardware or logic, a combination of the same, etc.

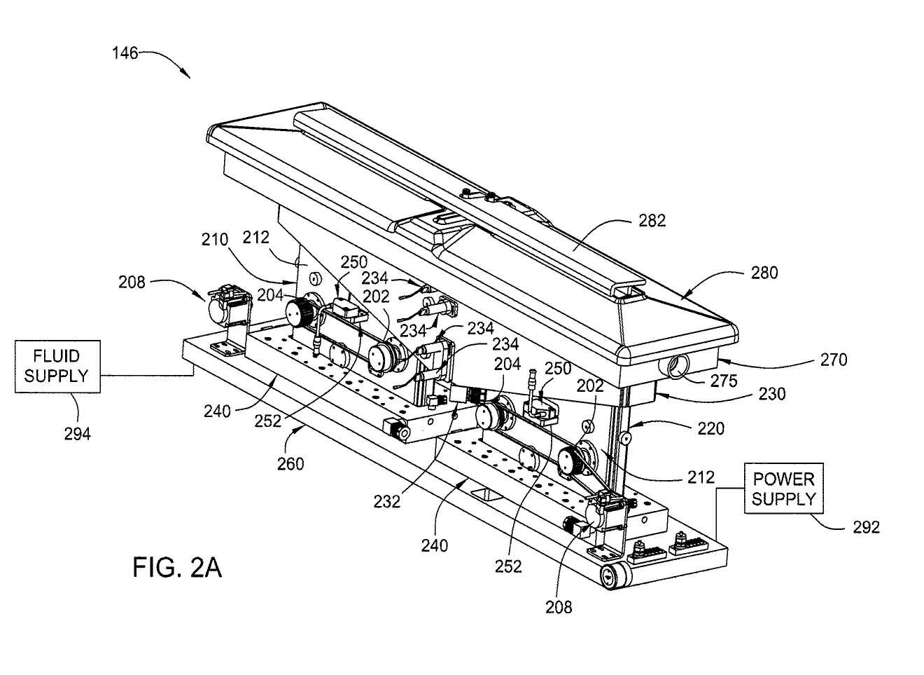

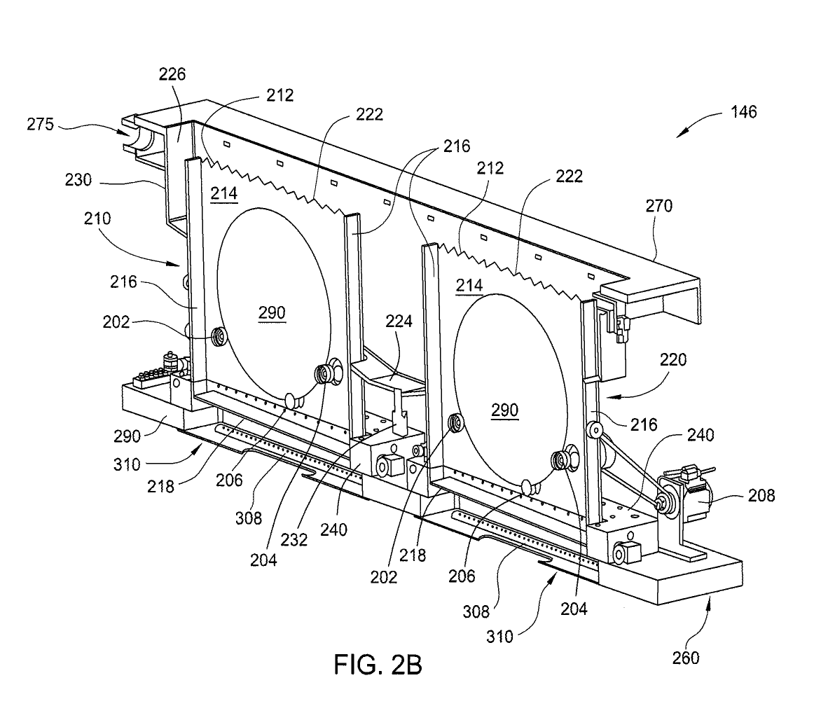

FIGS. 2A-2B respectively are perspective and cross-sectional views of one embodiment of the dual megasonic tank cleaner 146 which may be utilized to simultaneously clean multiple substrates using megasonic energy. The dual megasonic tank cleaner 146 includes two vertically arranged inner megasonic modules 210, 220 positioned adjacent to each other and coupled with an outer tank 230 adapted to function as an overflow catch basin for processing fluid that overflows the vertical inner megasonic modules 210, 220. The outer tank 230 and the vertical inner megasonic modules 210, 220 may comprise a material such as polyvinyl difloride (PVDF) or any other materials compatible with process chemistries. In one embodiment, the vertical inner megasonic module may be coupled with the outer tank 230 to form a unitary assembly using attachment techniques such as welding. The vertical inner megasonic modules 210, 220 may be coupled with the outer tank 230 such that the vertical inner megasonic modules 210, 220 extend partially below a bottom 224 of the outer tank 230.

In the embodiment shown, the vertical inner megasonic modules 210, 220 are positioned side by side such that the respective front walls 212 of each vertical inner megasonic module 210, 220 are parallel to each other and the perspective rear walls (not shown in this view) are parallel to each other. In one embodiment, the vertical inner megasonic modules 210, 220 may be slightly angled with respect to a vertical axis, for example, between 1 and 1.5 degrees in some embodiments, and up to 8 to 10 degrees in other embodiments. The megasonic modules 210, 220 are each coupled with a base 240 which provides support for each megasonic module 210, 220 and also functions as a manifold for fluid inlet and outlet to the vertical megasonic modules 210, 220. The dual megasonic tank cleaner 146 includes a common base plate 260 to which the megasonic modules 210, 220 are individually mounted. The dual megasonic tank cleaner 146 further includes an integrated exhaust manifold 270 coupled with a top 226 of the outer tank 230. In one embodiment, the exhaust manifold 270 has exhaust ports 275 for exhausting one or more vapors into the atmosphere. In one embodiment, the dual megasonic tank cleaner 146 includes a cover assembly 280 for positioning on the exhaust manifold 270. The cover assembly 280 helps protect the inside of the megasonic modules 210, 220 as well as preventing fumes from exiting the megasonic modules 210, 220. The cover assembly 280 also includes a sliding portion 282 which slides relative to the cover assembly 280 to allow for ingress and egress of substrates.

FIG. 2B is a cross-sectional perspective view of one embodiment of the dual megasonic tank cleaner 146 of FIG. 2A with the rear wall removed according to one embodiment of the present invention. The megasonic modules 210, 220 are shown in the vertical orientation in which the modules 210, 220 may be used in the dual megasonic tank cleaner 146. Each megasonic module 210, 220 includes a megasonic processing region 214 defined by the front wall 212, a rear wall 306 (not shown in this view), sidewalls 216, and a transducer 218 defining a bottom of the processing region.

The megasonic processing region 214 has width and depth dimensions that define an internal volume sufficient to hold a processing fluid and a substrate 290. In one embodiment, the substrate is partially immersed in processing fluid. In another embodiment, the substrate is fully immersed in processing fluid. A weir 222 is formed at the top of the front wall 212 and the rear wall 306 to allow fluid in the megasonic processing region 214 to overflow into the outer tank 230. The weir 222 and sidewalls 216 define an opening dimensioned to allow a substrate transfer assembly to transfer at least one substrate in and out of each megasonic module 210, 220.

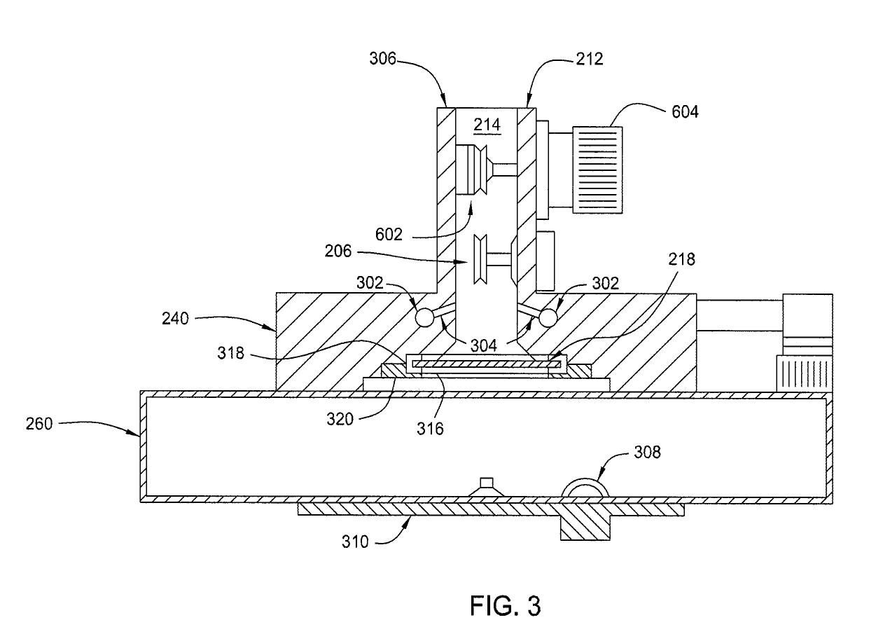

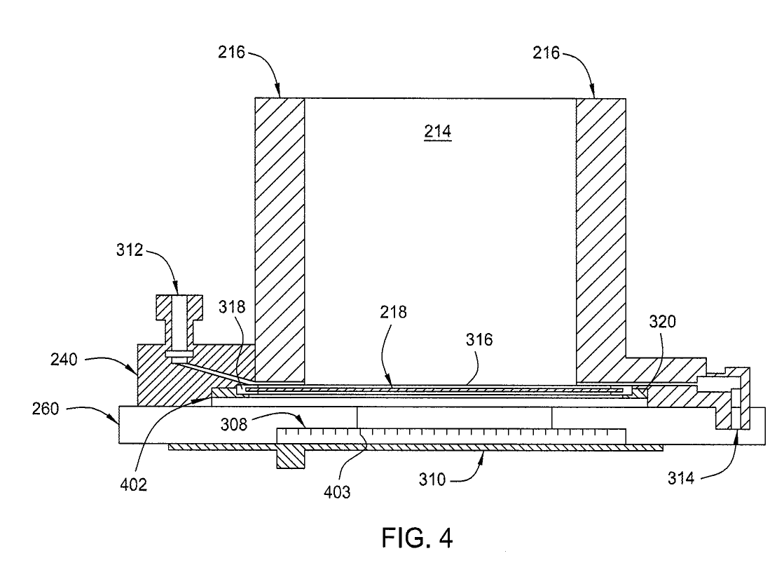

FIG. 3 is a partial cross-section view of one embodiment of the vertical megasonic module with the sidewall 216 removed and FIG. 4 is a partial cross-sectional view of one embodiment of the vertical megasonic module with the rear wall 306 removed. With reference to FIG. 3 and FIG. 4, an inlet manifold 302 configured to fill the megasonic processing region 214 with a processing fluid is formed in the base 240 of each megasonic module 210, 220. The inlet manifold 302 has a plurality of apertures 304 opening into the megasonic processing region 214 and formed in the front wall 212 and the rear wall 306 above the transducer 218. In one embodiment, the apertures 304 are angled to deliver processing fluid into the megasonic processing region 214 below the location of the substrate 290. An inlet port (not shown) and fluid supply 294 are coupled with the inlet manifold 302 for supplying fluid to the megasonic processing region 214.

With reference to FIGS. 2, 3, and 4, during processing, processing fluid may flow in from the fluid supply 294 and the inlet manifold 302 to fill the megasonic processing region 214 from the bottom via the plurality of apertures 304. The megasonic processing region 214 may be filled to a suitable level with a processing fluid. In one embodiment, the processing region 214 may be filled with processing fluid to a level allowing for total immersion of the substrate 290 in the processing fluid. In another embodiment, the processing region 214 may be filled with processing fluid to a level allowing for partial immersion of the substrate 290 in the processing fluid. The processing fluid may comprise deionized water (DIW), one or more solvents, a cleaning chemistry such as standard clean 1 (SC1), surfactants, acids, bases, or any other chemical useful for drying a substrate and/or rinsing films and/or particulates from a substrate.

As the processing fluid fills up the megasonic processing region 214 and reaches the weir 222, the processing fluid overflows the weir 222 into the outer tank 230. The outer tank 230 is sloped inward toward the center such that the overflow processing fluid from the first megasonic module 210 and the second megasonic module 220 flows toward an outlet port 232 located in the center of the outer tank 230 between the first megasonic module 210 and the second megasonic module 220. The outlet port 232 may be connected to a pump system (not shown). In one embodiment the outlet port 232 may be routed to a negatively pressurized container to facilitate removal, draining, or recycling of the cleaning fluid. The used processing fluid may be heated and filtered and prepared for recirculation back to the vertical megasonic modules 210, 220. Thus the outer tank 230 provides a common fluid recirculation system for both the first megasonic module 210 and the second megasonic module 220. In one embodiment, the outer tank 230 is dimensioned to hold between about 4 liters and about 5 liters of processing fluid. In one embodiment, the outer tank 230 is dimensioned to hold about 4.6 liters of processing fluid.

The outer tank 230 may also include a plurality of fluid level sensors 234 for detecting the level of processing fluid within the outer tank 230. When the level of processing fluid is low, the fluid level sensors 234 may be used in a feedback loop to signal the fluid supply 294 to deliver more processing fluid to the dual megasonic tank 146. Although four fluid level sensors 234 are shown in the embodiment of FIG. 2A, any number of fluid level sensors 234 may be included on the outer tank 230.

The megasonic transducer 218 is disposed in the base 240 of the vertical megasonic tank 210, 220 below the megasonic processing region 214. In one embodiment, the megasonic transducer 218 defines the bottom of the megasonic processing region 214. In another embodiment, the megasonic transducer 218 is disposed behind a window in the base 240. In one embodiment, the megasonic transducer 218 is held in place by a flange 320. In one embodiment, the transducer 218 is positioned in a u-shaped channel 318 (see FIG. 3). In one embodiment, the u-shaped channel 318 is formed as an integral part of the base module 240. In one embodiment, the u-shaped channel 318 may be formed by coupling the flange 320 (see FIG. 3) with the base module 240 wherein the u-shaped channel is defined between the base module 240 and the flange 320. The flange 320 allows for easy access to the transducer 218 without having to remove the vertical megasonic module 210, 220 from the base module 240.

With reference to FIG. 3, in one embodiment, a gasket 316 (see FIG. 3) surrounds the transducer 218 preventing processing fluid from leaking from the megasonic processing region 214. In one embodiment, the gasket 316 may be a single piece closed-loop gasket. In one embodiment, the gasket 316 comprises a material such that the gasket stretches upon installation and then contracts to fit the transducer 218. In one embodiment, the gasket 316 may comprise multiple pieces. In one embodiment, the gasket 316 comprises a perfluoroelastomer material such as Kalrez® available from DuPont Performance Elastomers L.L.C.

The megasonic transducer 218 is configured to provide megasonic energy to the megasonic processing region 214. The megasonic transducer 218 may be implemented, for example, using piezoelectric actuators, or any other suitable mechanism that can generate vibrations at megasonic frequencies of desired amplitude. The megasonic transducer 218 may comprise a single transducer or an array of multiple transducers, oriented to direct megasonic energy into the megasonic processing region 214. When the megasonic transducer 218 directs energy into the processing fluid in the megasonic processing region 214, acoustic streaming, i.e. streams of micro bubbles, within the processing fluid may be induced. The acoustic streaming aids the removal of contaminants from the substrate being processed and keeps the removed particles in motion within the processing fluid hence avoiding reattachment of the of the removed particles to the substrate surface. The transducer 218 may be configured to direct megasonic energy in a direction normal to the edge of the substrate 290 or at an angle from normal. In one embodiment, the megasonic transducer 218 is dimensioned to be approximately equal in length to the diameter of the substrate 290 to be cleaned. Thus, each portion of the face of the substrate 290 receives equal amounts of megasonic energy during the cleaning process. The transducer 218 is generally coupled to an RF power supply 292.

While two transducers 218 are shown, one for each megasonic module 210, 220, fewer or more transducers may be used. For example, a third transducer (not shown) may be placed between the first megasonic module 210 and the second megasonic module 220 to direct megasonic energy into both the first megasonic module 210 and the second megasonic module 220. In one embodiment, the third transducer may be placed in outer tank 230, wholly or partially submerged in the processing fluid. The third transducer may be oriented to generate vibrational energy which impacts the substrate 290 from the side, substantially parallel to the major surface(s) of the substrate. Although the transducers 218 are shown as rectangular shaped, it should be understood that transducers of any shape may be used with the embodiments described herein.

Additionally, the two transducers 218 need not be used together. For example, the transducer 218 of the first megasonic module 210 may be used alone or may be used at a different power level than the transducer 218 of the second megasonic module 220. The controller 190 may be adapted to control operation of the transducer 218. Each transducer 218 may provide energy continuously, periodically, or at any suitable cycle time.

In one embodiment, the transducer 218 may be air-cooled using an air cooling manifold 308 coupled with the transducer plate 310. The air-cooling manifold 308 may comprise a piece of tubing having several apertures 403 to direct a cooling fluid such as air toward the backside of the megasonic transducer 218. In one embodiment the tubing comprises aluminum or any other suitable material that does not react with the processing fluid. The tubing may be coupled with the transducer plate 310 by welding or any other suitable attachment technique. Typically, a large transducer requires a significant amount of energy to operate and thus generates a significant amount of heat during operation. The ability to air-cool the transducer 218 during processing prevents adversely affecting transducer adhesives and surrounding material thus extending the life of the megasonic transducer 218 and reducing overall system maintenance.

Referring to FIG. 4, the base 240 of the megasonic module 210, 220 also includes a fluid inlet 312 and a fluid outlet 314. After processing, DI water or other suitable fluid may be flowed through the inlet 312 to flush the tank and then drained through the outlet 314 allowing the processing region to be replenished with clean rinsing fluid from an intake manifold. In one embodiment, the bottom 402 of the megasonic module 210, 220 is sloped between the fluid inlet 312 and the fluid outlet 314 to allow for rinsing and cleaning of the megasonic modules 210, 220. In one embodiment, the bottom 402 of the megasonic module 210, 220 is sloped between about 1 degree and about 3 degrees, for example about 1.5 degrees.

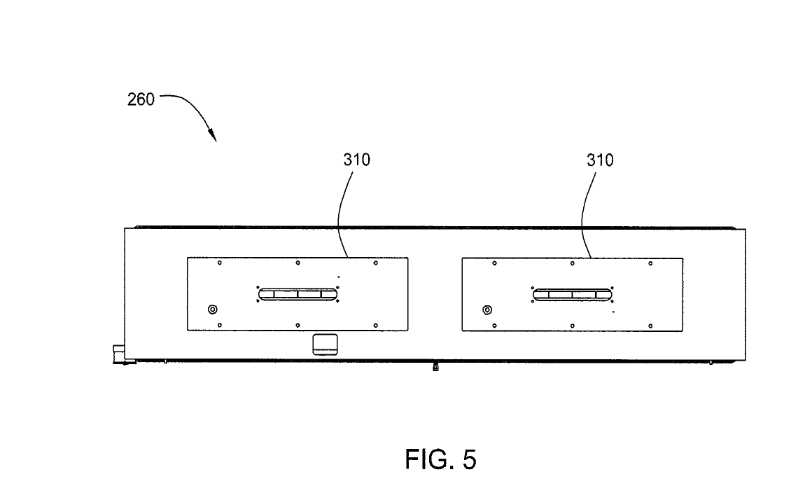

FIG. 5 is a bottom view of one embodiment of the dual megasonic tank cleaner of FIG. 2A showing one embodiment of the base plate 260. The base plate 260 comprises two removable transducer plates 310. Removal of each transducer plate 310 allows for easy access to each transducer 218 for maintenance or replacement. The transducer plate 310 holds interface connections for each transducer 218 allowing for easy access to connect a RF power supply 292 from the underside of the system.

Referring to FIG. 2B, roller assemblies 202, 204 are positioned above the transducer 218 to vertically support a substrate 290 in line with the transducer 218. The roller assemblies 202, 204 are rotatable and each preferably comprises a rotatable wheel having a v-shaped groove 610 for supporting a substrate with minimal contact. Roller assemblies 202, 204 extend between the front wall 212 and the rear wall 306 of each megasonic module 210, 220. The roller assemblies 202, 204 are used to support and rotate the substrates positioned in the megasonic processing region 214. In one embodiment, the roller assemblies 202, 204 shown in FIGS. 2A and 2B may be spaced between about 110 degrees and between about 130 degrees apart, between about 55 degrees and 65 degrees from vertical. In one embodiment, the roller assemblies 202, 204 shown in FIGS. 2A and 2B may be spaced about 118 degrees apart, 59 degrees from vertical, in order to provide good support for the substrate and also to provide clearance for a substrate gripper assembly used to deposit or retrieve the substrate 290 from each megasonic processing region 214. It has been found that a spacing of about 118 degrees provides more friction on the edge of the substrate which prevents the substrate from slipping without rotating.

The gripper assembly may comprise one or more pads, pincers or other gripping surfaces for contacting and/or supporting a substrate being loaded into or unloaded from the megasonic processing region 214. In some embodiments, the gripper may be adapted to move vertically, such as via rail or other guide, as a substrate is raised or lowered relative to the megasonic processing region 214.

A stabilizing mechanism 206 is positioned so as to contact and stabilize the substrate 290 positioned on the roller assemblies 202, 204. The stabilizing mechanism 206 may be positioned at any point so as to contact the side of the substrate 290 and sufficiently reduce or prevent the substrate 290 from wobbling when rotating on the roller assemblies 202, 204.

A motor 208 which may be disposed on the base plate 260 or in any other suitable location is operatively coupled to one or both of the roller assemblies 202, 204. In one embodiment, a separate drive mechanism may be included for each roller assembly 202, 204. In another embodiment, only the first roller assembly 202 is driven and the second roller assembly 204 may rotate passively as an idler.

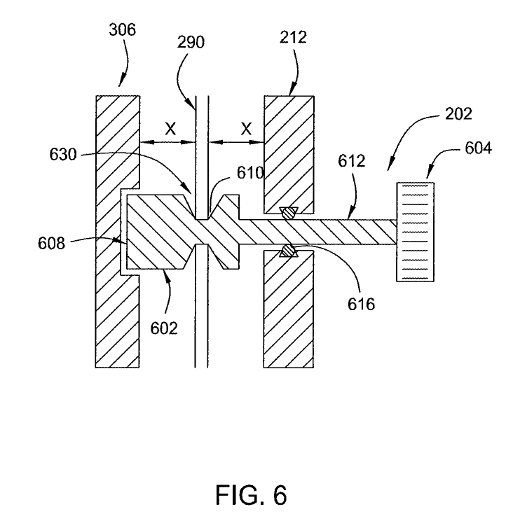

FIG. 6 is a partial cross sectional view of one embodiment of a megasonic tank depicting one embodiment of a roller assembly. The roller assembly 202 comprises a roller 602 adapted to support a substrate 290, a gear 604 which may be coupled with the motor 208, and a shaft 612 which couples the gear 604 with the roller 602. In some embodiments, a single motor maybe used to drive both sets of rollers and/or a single roller in each set. In one embodiment, the roller assembly 202 is positioned such that the substrate 290 is positioned in the center of the megasonic processing region 214, for example, the distance between the substrate and the front wall 212 and the distance between the substrate and the rear wall 306 is a distance X. In one embodiment, the distance X is between about 10 mm and about 20 mm. In one embodiment, the distance X is about 15 mm. Positioning the substrate in the center of the processing region 214 allows for even distribution of energy and processing fluid relative to the substrate. The roller assembly 202 extends the entire width of the megasonic processing region 214 between the rear wall 306 and the front wall 212 to prevent the substrate 290 from falling into the megasonic processing region 214 and damaging the transducer 218. In one embodiment, the roller 602 extends into a recess 608 formed in the rear wall 306. The recess 608 is dimensioned to allow for rotation of the roller 602 but also holds the roller 602 securely enough to prevent the roller 602 from slipping out of the recess 608. The roller 602 may be magnetically coupled with the rear wall 306. The roller 602 has a groove 610 which can be v-shaped as shown or may be otherwise shaped, such as u-shaped. When in contact with, the roller 602, the grooves 610 grip the edge of the substrate 290, thus causing the substrate 290 to rotate with the rotation of the rollers. As shown, a gap 630 exists between the roller 602 and the substrate 290. The shaft 612 of the roller assembly 202 extends through an opening in the front wall 212 of the megasonic processing region 214. A shaft seal 616 is positioned in the opening to seal the volume between the shaft 612 and the opening.

The controller 190 may be coupled to the motor 208 and control the motion and/or rotation of the rollers assemblies 202. The controller 190 may also receive signals from a rotation sensor (not shown) that monitors the rotation of the roller assemblies 202 and provides an indication of the rotational speed of the substrate. For example, one or more of the roller assemblies 202 may include a magnet (not shown), and the rotation of the magnet may be used to indicate roller and substrate rotation rate.

Referring to FIG. 2A, a substrate sensor 250 may be coupled to the front wall 212, such as via a support member 252. The sensor 250 may comprise an infrared sensor or other suitable sensor adapted to determine whether a substrate surface is positioned in front of or in the vicinity of the sensor. In some embodiments, the substrate sensor 250 may be rotatable between a vertical, active position and a horizontal, inactive position.

### Exemplary Operation of the Vertical Megasonic Module

In operation, according to some embodiments of the invention, the first megasonic module 210 and the second megasonic module 220 contain sufficient fluid so as to submerge the entire substrate. When the substrates 290 are positioned on the roller assemblies 202, 204 in each corresponding megasonic module 210, 220, the substrates 290 are in line with the transducer 218 and centered in the megasonic processing region 214.

In operation, the transducer 218 is energized and begins oscillating at a megasonic rate. The transducer 218 may be supplied with power at a power range from about 200 watts to about 1,000 watts, such as between about 300 watts and 500 watts, for example, 400 watts. Megasonic energy is therefore coupled to the fluid and travels upward therethrough to travel parallel to the major substrate surfaces and to contact at least the edge surfaces of the substrate 290. The motor 208 is energized and rotates the first roller assembly 202 causing the substrate 290 to rotate. As the substrate 290 rotates, the second roller assembly 204 passively rotates therewith, thus preventing unnecessary friction between the second roller assembly 204 and the substrate 290 while also reducing slippage which could damage the substrate. The stabilizing mechanism 206 contacts the edge of the substrate 290, reducing and possibly preventing wobbling of the substrate 290.

After the substrate 290 has completed a desired number of revolutions, the robot transfers the substrate 290 to another cleaning station or a drier, and positions new substrates 290 onto the first roller assembly 202 and the second roller assembly 204.

In one embodiment, the cleaning cycles of each substrate 290 in megasonic module 210 and megasonic module 220 are synchronized to occur at the same time. In another embodiment the cleaning cycles of each substrate 290 are off-set.

While the foregoing is directed to embodiments of the present invention, other and further embodiments of the invention may be devised without departing from the basic scope thereof, and the scope thereof is determined by the claims that follow.

1. An apparatus for cleaning multiple substrates, comprising:
an outer tank for collecting overflow processing fluid comprising at least one sidewall and a bottom;
a first inner megasonic module dimensioned to contain a processing fluid and a substrate, wherein the first inner megasonic module is positioned partially within the outer tank, the first inner megasonic module comprising:
one or more roller assemblies positioned to hold the substrate in a substantially vertical orientation; and
a transducer positioned in the first inner megasonic module to direct vibrational energy through the processing fluid toward the substrate;
a second inner megasonic module dimensioned to contain a processing fluid and a substrate, wherein the second inner megasonic module is positioned partially within the outer tank, the second inner megasonic module comprising:
one or more roller assemblies adapted to hold the substrate in a substantially vertical orientation; and
a transducer positioned in the second inner megasonic module to direct vibrational energy through the processing fluid toward the substrate.

2. The apparatus of claim 1, wherein the first inner megasonic module and the second inner megasonic module are oriented approximately vertically within the outer tank and side-by side such that a respective front wall of the first inner megasonic module and a respective front wall of the second inner megasonic module are parallel to each other and a respective rear wall of the first inner megasonic module and a respective rear wall of the second inner megasonic module are parallel to each other.

3. The apparatus of claim 1, wherein the first inner megasonic module and the second inner megasonic module each comprise a processing region that has width and depth dimensions that define sufficient internal volume to hold the processing fluid and the substrate of a desired size.

4. The apparatus of claim 1, wherein the outer tank is angled to allow processing fluid to drain toward the center of the outer tank.

5. The apparatus of claim 1, wherein the outer tank, the first inner megasonic module, and the second inner megasonic module form a unitary assembly.

6. The apparatus of claim 1, wherein the inner megasonic modules extend partially below the bottom of the outer tank.

7. The apparatus of claim 1, wherein the transducer defines a bottom of a processing region of the first inner megasonic module and is positioned to direct megasonic energy in a direction substantially parallel to a sidewall of a major surface of a vertically oriented substrate.

8. The apparatus of claim 1, wherein the transducer is dimensioned to be approximately equal in length to the diameter of the substrate to be cleaned.

9. An apparatus for cleaning multiple substrates, comprising:
an outer tank;
a first inner megasonic module having vertical walls and coupled with the outer tank; and
a second inner megasonic module having vertical walls and coupled with the outer megasonic module, the first inner megasonic module and the second inner megasonic module each comprising:
a plurality of rotatable roller assemblies positioned to support a substrate in a substantially vertical orientation between the walls; and
a transducer positioned below the roller assemblies to deliver megasonic energy toward the substrate.

10. The apparatus of claim 9, wherein the first inner megasonic module tank and the second inner megasonic module are positioned side-by-side such that the respective front walls of each module are parallel to each other and respective rear walls of each module are parallel to each other.

11. The apparatus of claim 10, wherein at least one of the plurality of roller assemblies extends between the respective front walls and the respective rear walls of the inner megasonic module.

12. The apparatus of claim 9, wherein the plurality of rotatable roller assemblies comprise two roller assemblies spaced about 118 degrees apart, 59 degrees from vertical.

13. The apparatus of claim 11, wherein each inner megasonic module further comprises a substrate stabilizing mechanism.

14. The apparatus of claim 11, wherein the first megasonic module and the second megasonic module are mounted to a common base plate.

15. The apparatus of claim 14, wherein the transducer is coupled with the common base plate.

16. The apparatus of claim 14, wherein the first megasonic module and the second megasonic module each have a fluid inlet and a fluid outlet to allow for rinsing and cleaning of the modules.

17. The apparatus of claim 16, wherein a bottom of each inner module is sloped between the fluid inlet and the fluid outlet to allow for the draining of rinsing and cleaning fluid.

18. The apparatus of claim 17, wherein the bottom of each inner module is sloped between about 1 degree and about 3 degrees.

19. The apparatus of claim 14, wherein at least one of the vertical walls has a plurality of angled apertures for delivering processing fluid into the inner modules and the plurality of angled apertures are located below the plurality of roller assemblies.

20. A method for processing multiple substrates, comprising:
introducing each substrate into a separate vertical processing chamber, each vertical processing chamber, at least partially housed within an outer tank, wherein each vertical processing chamber comprises:
an inner megasonic module dimensioned to contain a processing fluid and a substrate, wherein the inner megasonic module is positioned partially within the outer tank, the inner megasonic module comprising:
one or more roller assemblies positioned to hold the substrate in a substantially vertical orientation; and
a transducer positioned in the inner megasonic module to direct vibrational energy through the processing fluid toward the substrate;
rotating the substrates in each inner megasonic module; and
directing megasonic energy from below the inner tanks toward the substrates.
